(19) United States
(12) Patent Application Publication
(10) Pub. No.: US 2026/0250006 A1
(43) Pub. Date: Aug. 27, 2026

(54) AIRCRAFT PROPULSION UNIT WITH MAIN AND AUXILIARY COOLING SYSTEM

(71) Applicant: Rolls-Royce Deutschland Ltd & Co KG, Blankenfelde-Mahlow (DE)

(72) Inventors: Daniel PROKEIN, Fürth (DE); William HUNTER, Ottobrunn (DE); Wolfram BIRKMAYER, Hirschaid (DE)

(21) Appl. No.: 19/160,252

(22) PCT Filed: Mar. 13, 2024
(86) PCT No.: PCT/EP2024/056611

§ 371 Date: Aug. 27, 2025

(30) Foreign Application Priority Data
Mar. 14, 2023 (DE) 10 2023 106 282.4

(51) Int. Cl. B64D 33/10; B64D 27/34; H02K 5/20; H02K 9/06; H02K 9/22

(52) U.S. Cl. CPC B64D 33/10; B64D 27/34; H02K 5/207; H02K 9/06; H02K 9/227

(57) ABSTRACT

A drive unit for a vehicle, in particular for an aircraft, includes: an electric motor; a main cooling system for cooling the electric motor; and an auxiliary cooling system, which is independent of the main cooling system, for cooling the electric motor. The main cooling system has a greater cooling capacity than the auxiliary cooling system.

This present patent document is a § 371 nationalization of PCT Application Serial No. PCT/EP 2024/056611, filed Mar. 13, 2024, designating the United States, and this patent document also claims the benefit of the German patent application DE 102023106282.4, filed on Mar. 14, 2023, which is hereby incorporated by reference in its entirety.

### TECHNICAL FIELD

The present disclosure relates to a drive unit for a vehicle, e.g., for an aircraft, and to an aircraft having such a drive unit. In particular, the present disclosure relates to a main and an auxiliary cooling system and an aircraft drive unit having such a main and an auxiliary cooling system.

### BACKGROUND

Aircraft are driven in various design embodiments. Internal combustion engines, for example piston engines or gas turbine engines, enable long ranges and high speeds. Drives having one electric motor or a plurality of electric motors enable the use of sustainably produced energy and are in many instances particularly low-maintenance and quiet. Advances in battery and fuel cell technology open ever more fields of application of electric drives.

In electric motors and other electric machines, the aim is to continuously improve the target variables of energy efficiency, power-to-weight ratio, reliability and service life. However, some of these target variables conflict with one another and with other requirements. In vehicle construction, for example, not only energy efficiency but also, especially, installation space requirements due to limited available space are to the fore. For low energy consumption in mobile applications, a low weight of the drives is also important.

The requirements described apply particularly to the application in aircraft, where the future of the electrification of aircraft drive systems depends significantly on the power density of the motors or generators to be used. The reliability of the drive units used in the aviation sector is also particularly relevant, as a failure of a drive unit can have particularly serious consequences.

US 2006/0125332 A1 proposes a partially redundant cooling system for an electric submarine drive, which, however, results in a high total weight.

### SUMMARY AND DESCRIPTION

The object of the present disclosure is to provide a reliable drive unit with the lowest possible weight.

In a first aspect, a drive unit for a vehicle is provided, in particular for an aircraft. The drive unit comprises an electric motor, a main cooling system for cooling the electric motor, and an auxiliary cooling system, independent of the main cooling system, for cooling the electric motor, wherein the main cooling system has a greater cooling capacity than the auxiliary cooling system.

This is based on the concept of providing an auxiliary cooling system in the event of a failure of the main cooling system, the auxiliary cooling system being less powerful than the main cooling system and therefore potentially having a comparatively lower weight. The auxiliary cooling system can be activatable in the event of a failure of the main cooling system and/or support the main cooling system also during regular operation. In the event of a failure of the main cooling system, heat from the electric motor can thus still be dissipated, albeit to a lesser extent than with the main cooling system. However, this may be sufficient to continue to operate the electric motor, even if the power level is reduced, and/or for a limited time. However, this may still allow for a controlled and safe landing in an aircraft, which may lead to greater difficulties in the case of a fully deactivated drive unit. This is because even if the auxiliary cooling system (as optionally provided) thus cannot dissipate the entire heat output (e.g. in a certain operating state of the vehicle and/or the electric motor), the auxiliary cooling system can reduce a temperature increase of the electric motor (in comparison to a vehicle without the auxiliary cooling system). Nevertheless, the auxiliary cooling system adds only a relatively lower weight. Since the two cooling systems are mutually independent, failure of one does not result in failure of the other. The drive unit has a maximum drive output. The cooling requirement of the drive unit may be the highest at maximum (100%) drive output and decrease as the drive output decreases.

The drive unit can furthermore comprise a rotor unit that is driven by the electric motor and has a plurality of rotor blades. The drive unit can drive an aircraft, for example.

The rotor unit is, for example, a propeller or a fan.

The main cooling system can have one or a plurality of flow paths for a cooling fluid. Alternatively, or additionally, the auxiliary cooling system can have one or a plurality of flow paths for a cooling fluid. Efficient cooling is possible in this way.

The flow path or the flow paths of the main cooling system is/are separate from the flow path or the flow paths of the auxiliary cooling system. For example, there is no fluidic connection between them; the flow paths of the main cooling system and of the auxiliary cooling system are in particular fluidically separated from one another. A hydraulic separation of the flow paths of the main cooling system and of the auxiliary cooling system is facilitated by the differently designed cooling systems, especially in comparison with two identical, e.g. redundant, cooling systems. In this way, a particularly high level of fail-safety can be achieved.

The cooling fluid of the main cooling system can be a liquid, e.g. water or an oil. This enables a particularly high level of cooling capability.

Alternatively, the cooling fluid of the main cooling system can be air. This enables a particularly simple construction.

The cooling fluid of the auxiliary cooling system can also be a liquid, e.g. water or an oil. In this case, too, this enables a relatively high cooling capacity as well as a small installation size.

Alternatively, the cooling fluid of the auxiliary cooling system can also be air, which in turn enables a particularly simple construction.

The electric motor can be connected to the flow path or the flow paths of the main cooling system and/or to the flow paths of the auxiliary cooling system by way of a heat sink. This allows greater freedom in the spatial design embodiment of the drive unit as well as a separation of the components of the two cooling systems.

The flow path or the flow paths of the auxiliary cooling system can externally surround the flow path or the flow paths of the main cooling system. For example, the main cooling system can thus be disposed close to coils of the electric motor, while the auxiliary cooling system is more remote from the latter. In this way, the main cooling system can provide particularly effective cooling.

Optionally, the flow path or the flow paths of the main cooling system and/or the flow path or the flow paths of the auxiliary cooling system are designed in a meandering manner. Thus, with a simple structure, a reliable hydraulic separation between the two cooling systems can be achieved and an independence of the two cooling systems from one another can be achieved, especially if the auxiliary cooling system uses a liquid cooling fluid (wherein heat generated at coils of the electric motor can also be discharged particularly well).

The flow path or the flow paths of the main cooling system can have both a larger cross section(s) and a smaller cross section(s) than the flow path or the flow paths of the auxiliary cooling system. The flow path or the flow paths of the main cooling system can have different geometries than the flow path or the flow paths of the auxiliary cooling system. The flow path or the flow paths of the main cooling system may be designed differently from, in particular have a larger wettable or wetted surface than, the flow path or the flow paths of the auxiliary cooling system.

The respective cooling fluid can be circulatable by a conveying device through the flow paths or can be flowable in the form of external air from an inlet to an outlet. The main cooling system and the auxiliary cooling system can each be designed for continuous operation. The main cooling system and the auxiliary cooling system can be designed to release heat to the external air independently of one another.

The main cooling system can comprise a heat exchanger for discharging heat, in particular to external air, and/or be able to be passed through by a flow of external air. The auxiliary cooling system can comprise separately from the main cooling system a heat exchanger for discharging heat, in particular to external air, and/or be able to be passed through by a flow of external air.

The electric motor can comprise a stator with electric coils and a rotor that is rotatable relative to the stator. The electric motor can be a radial flux machine, a transverse flux machine or an axial flux machine. Furthermore, the electric motor can be an external rotor or an internal rotor motor.

The coils of the electric motor can be in contact with cooling fluid flowing through the flow path or the flow paths of the main cooling system, i.e. be in direct contact with the latter, without interposition of a heat sink. This enables particularly efficient cooling.

The flow path or the flow paths of the auxiliary cooling system can extend between the coils of the electric motor and the rotor. In this way, heat can be discharged particularly effectively, because the part of the coils that faces the rotor may generate an increased, in particular the greatest, loss-to-heat output and has the greatest cooling requirement. In certain examples, the auxiliary cooling system can be specified to cool the hottest spots of the electric motor during operation (“hot spots”), in particular to cool the latter more intensely than other regions of the electric motor.

The flow path or the flow paths of the main cooling system and/or the flow path or the flow paths of the auxiliary cooling system can extend in grooves between teeth of the stator, in particular be disposed therein conjointly with the coils. In this way, particularly effective cooling and a small construction mode are possible.

The main cooling system can be designed in such a way that it can discharge (and/or provide the cooling requirement for) more than 50%, in particular 100%, of the heat output generated by the electric motor, and/or the auxiliary cooling system can be designed in such a way that it can discharge (and/or provide the cooling requirement for) a maximum of less than 100%, in particular less than 50%, of the heat output generated by the electric motor, in each case, for example, based on the maximum drive output of the drive unit, in particular of the electric motor. It can be provided that the main cooling system and the auxiliary cooling system conjointly can discharge (and/or provide the cooling requirement for) more than 100% of the heat output generated by the electric motor. This can provide a particularly high level of reliability in terms of a complete failure of the drive unit due to a failure of a cooling system. The heat output corresponds, for example, to a loss-to-heat output from the electric motor. Furthermore, it can be provided that the main cooling system is designed in such a way that it can absorb the loss-to-heat output that is emitted when the electric motor continuously provides a drive output of more than 50%, in particular 100%, of its maximum drive output. Alternatively or additionally, the auxiliary cooling system can be designed in such a way that it can absorb at most the loss-to-heat output that is emitted when the electric motor continuously provides a drive output of less than 100%, in particular less than 50% of its maximum drive power (and optionally not more than that).

The electric motor can have a plurality of mutually independent electrical strands, wherein the main cooling system can be designed to cool the same or a different number of strands than the auxiliary cooling system. For example, the auxiliary cooling system cools fewer strands than the main cooling system. In the event of a failure of the main cooling system, the strand that is not cooled by the auxiliary cooling system can be shut down while the remaining strands continue to be operated.

Provided according to one aspect is an aircraft comprising the drive unit according to any design embodiment described herein. In terms of the advantages, reference is made to The aircraft can furthermore comprise at least one further drive unit, wherein the main cooling system and/or the auxiliary cooling system are/is specified to cool the electric motors of both the drive unit and the at least one further drive unit. For example, the aircraft has a plurality of main cooling systems and a smaller number of auxiliary cooling systems that are connected to a plurality of electric motors. It should also be noted that providing a main cooling system and a comparatively weaker auxiliary cooling system at a particularly low overall weight can significantly increase the reliability in terms of a failure of the entire cooling capacity. Since the cooling systems are mutually independent, in particular different from one another, the risk of a single point of failure, which leads to a total failure of the cooling capacity, or a failure that leads to the failure of both cooling systems, can also be significantly reduced.

### BRIEF DESCRIPTION OF THE DRAWINGS

Embodiments are now described by way of example with reference to the figures, in which, in schematic illustrations:

FIG. 1 shows a view of an example of an aircraft with two drive units.

FIG. 2 shows a sectional view of one of the drive units of the aircraft according to FIG. 1.

FIG. 3 shows part of a cross section of an electric motor of the drive unit according to FIG. 2.

FIG. 4 shows a block diagram of an exemplary main cooling system of the drive unit according to FIG. 2.

FIGS. 5 to 7 each show part of a cross section of an example of an electric motor for the drive unit similar to that shown in FIG. 2, having in each case a main cooling system and an auxiliary cooling system, wherein the auxiliary cooling system according to FIG. 7 by way of example has flow-conducting tubes.

FIG. 8 shows a view of a meandering profile of a flow path of the auxiliary cooling system according to FIG. 7, by way of example in the form of the flow-conducting tube.

FIGS. 9 to 11 show in each case part of a cross section of an electric motor for the drive unit according to FIG. 2, having in each case a main cooling system and an auxiliary cooling system, wherein provided according to FIG. 9 is a cover 108A that has two functions, specifically to close a flow path of the main cooling system and to provide a separation between the cooling circuits of the main cooling system and of the auxiliary cooling system.

FIGS. 12A to 12E show potential allocations of examples of one or a plurality of main cooling system(s) and of one or a plurality of auxiliary cooling system(s) to a plurality of electrical strands of one or a plurality of electric motors.

### DETAILED DESCRIPTION

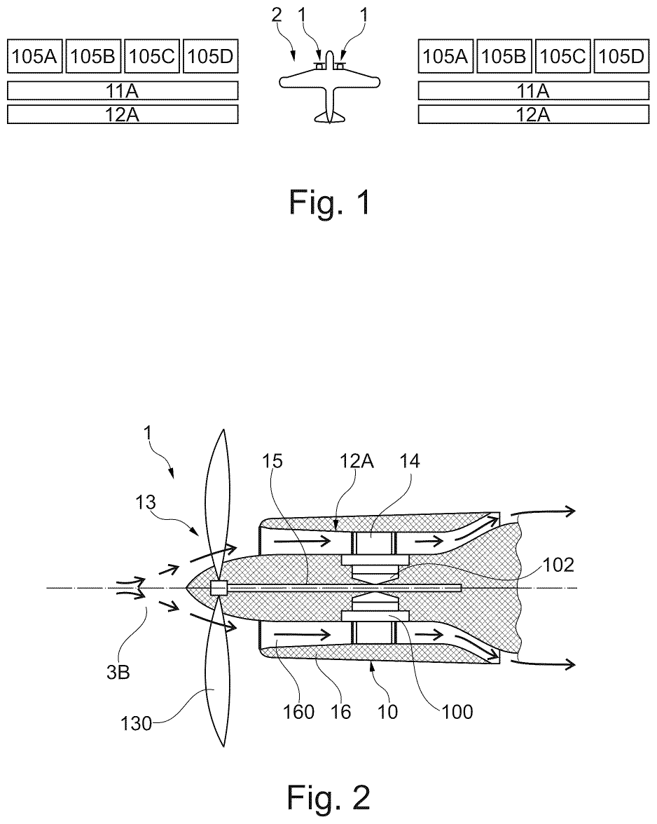

FIG. 1 shows an aircraft 2 in the form of an electrically (or alternatively partially electrically) driven aircraft. The aircraft 2 comprises a plurality of, presently two, electric drive units 1, each having a propeller. The aircraft 2 furthermore comprises an energy source in the form of an electric battery (wherein other energy storage devices/systems or energy sources are also conceivable, e.g., a fuel cell and/or a gas turbine with a generator). The drive units are supplied with energy by the energy source.

Each of the drive units 1 comprises an electric motor with, here by way of example, a plurality of electrical strands 105A-105D (lanes), which are shown here schematically in the form of blocks. Each of the strands 105A-105D is electrically independent of the other strands 105A-105D. Each of the strands 105A-105D can be impinged with electric current in order to drive the drive unit 1. The failure of a strand 105A-105D does not therefore lead to a failure of the entire drive unit 1. It should be noted, however, that the electric motor 10 could alternatively also only have one strand.

Furthermore, each of the drive units 1 comprises in each case a main cooling system 11A and an auxiliary cooling system 12A. In each of the drive units 1, both the main cooling system 11A and the auxiliary cooling system 12A are designed to cool each of the strands 105A-105D.

FIG. 2 shows one of the drive units 1. The drive unit 1 comprises an electric motor 10, a main cooling system 11A for cooling the electric motor 10, and an auxiliary cooling system 12A, independent of the main cooling system 11A, for cooling the electric motor 10, wherein the main cooling system 11A has a greater cooling capacity than the auxiliary cooling system 12A. The main cooling system 11A can therefore dissipate a greater amount of heat per unit of time than the auxiliary cooling system 12A, e.g. at least 10% more than the auxiliary cooling system 12A, at least 20% more or at least 40% more.

The drive unit 1 furthermore comprises a rotor unit 13. The rotor unit 13 comprises a plurality of, presently by way of example two, rotor blades 130. The rotor unit 13 in the example shown is a propeller. The rotor unit 13 is coupled to the electric motor 10 by a shaft 15. The electric motor 10 drives the rotor unit 13 by way of the shaft 15. The electric motor 10 is presently designed as an internal rotor motor, wherein a stator 100 surrounds a rotor 102 that is rotatable relative to the stator 100. The rotor 102 is fixedly connected to the shaft 15.

The electric motor 10 is assembled in a housing 16 of the drive unit 1, which forms an air duct 160. The air duct 160 supplies air as cooling fluid 3B to a heat sink 14 of the auxiliary cooling system 12A (alternatively or additionally to a heat sink of the main cooling system 11A).

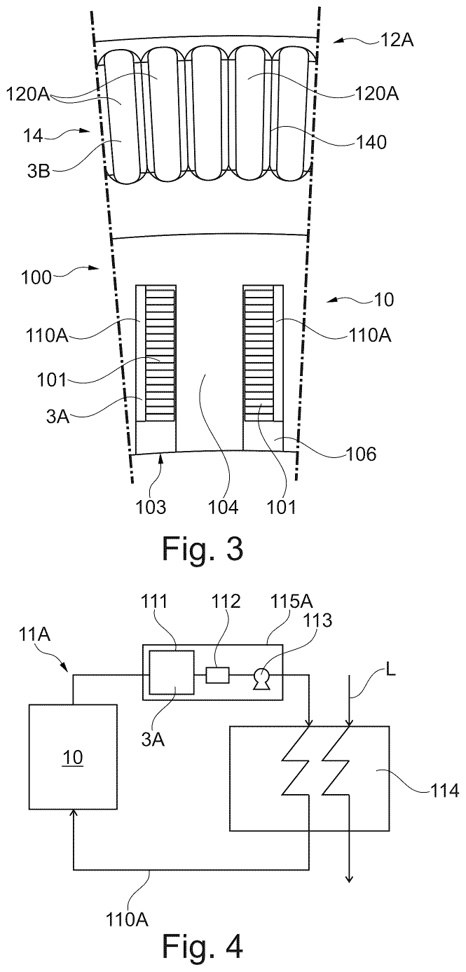

FIG. 3 visualizes further details of the main cooling system 11A and of the auxiliary cooling system 12A. The auxiliary cooling system 12A comprises a plurality of flow paths 120A for cooling fluid 3B. The flow paths 120A of the auxiliary cooling system 12A extend in each case between two of the fins 140 that are formed by a heat sink 14 of the auxiliary cooling system 12A. The flow paths 120A of the auxiliary cooling system 12A are disposed concentrically about the electric motor 10. Each of the flow paths 120A (here each in the form of a flow duct) is supplied with air by way of the air duct 160. In the present example, the rotor unit 13 and the natural velocity of the aircraft 2 force air through the air duct 160 and thus through the flow paths 120A of the auxiliary cooling system 12A.

The main cooling system 11A also comprises a plurality of flow paths 110A for a liquid, in this case oil, as cooling fluid 3A. As can be seen by FIG. 3, the flow paths 110A of the main cooling system 11A are separate from the flow paths 120A of the auxiliary cooling system 12A. The main cooling system 11A cools using a different cooling fluid 3A than the auxiliary cooling system 12A.

The flow paths 110A of the main cooling system 11A presently extend in grooves 103 between teeth 104 of the stator 100. Electric coils 101 of the electric motor 10 are furthermore disposed in the grooves 103. The coils 101 are each wound about a tooth 104.

Each of the coils 101 can comprise wires of one strand 105A-105D, two, three or four strands 105A-105D. By way of example, the coils 101 are encapsulated in the grooves 103 using a (optional) filling material, in the present case a potting compound 106, for example a resin, e.g. epoxy resin. The flow paths 110A of the main cooling system 11A are directly contiguous to the coils 101. The cooling fluid 3A flowing through the flow paths 110A of the main cooling system 11A thus sweeps across the coils 101.

The flow paths 110A of the main cooling system 11A are disposed closer to the coils 101 of the electric motor 10 than the flow paths 120A of the auxiliary cooling system 12A. The flow paths 120A of the auxiliary cooling system 12A externally surround the flow paths 110A of the main cooling system 11A.

The electric motor 10 is connected to the flow paths 120A of the auxiliary cooling system 12A by way of the heat sink 14.

According to FIG. 3, direct oil cooling by the main cooling system 11A, and indirect air cooling by the auxiliary cooling system 12A, is thus provided.

A groove closure wedge not shown can be provided to secure the coils 101 in position and/or to seal a flow path (of the main cooling system 11A and/or of the auxiliary cooling system 12A).

FIG. 4 visualizes the exemplary construction of the main cooling system 11A, wherein the electric motor 10 is visualized only by a block. The main cooling system 11A comprises a conveying device 115A with an optional reservoir 111 for the cooling fluid 3A, an optional filter 112 and a pump 113. The pump 113 pumps cooling fluid 3A from the reservoir 111 in a filtered manner to a heat exchanger 114. In the heat exchanger 114, a fluid flowing through the latter, here by way of example air L, cools the cooling fluid 3A. The cooled cooling fluid 3A is conveyed through the flow paths 110A through the electric motor 10 and thus cools the latter. The cooling fluid 3A is then fed back to the conveying device 115A. The cooling fluid 3A thus circulates multiple times through the electric motor 10.

In the present example, the main cooling system 11A is designed to provide 100% of the cooling requirement of the electric motor 10. The main cooling system 11A is thus so powerful that it can completely cool the electric motor 10 for regular operation. The auxiliary cooling system 12A is specified such that it can absorb the loss-to-heat output that is discharged when the electric motor 10 continuously delivers a drive output (e.g. shaft output) of 25% of its maximum drive output (e.g. shaft output).

Alternatively, or in addition, the auxiliary cooling system 12A can be specified to provide a maximum of 25% of the cooling requirement of the electric motor 10 (e.g. at the maximum drive output of the electric motor 10). The auxiliary cooling system 12A is thus so powerful that 25% of the heat output delivered by the electric motor 10 in regular operation can be cooled.

If the main cooling system 11A thus fails, then the electric motor 10 can continue to be operated at reduced output.

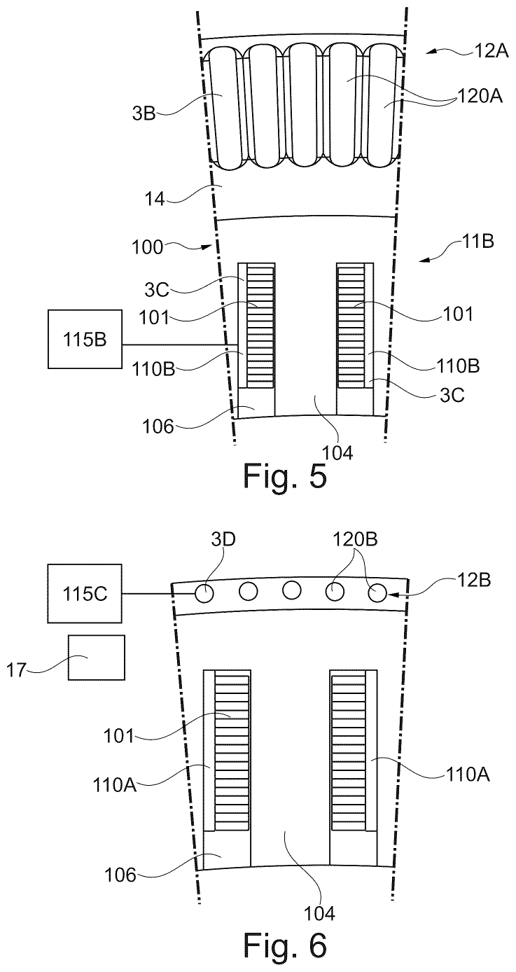

FIG. 5 visualizes an alternative in which the main cooling system 11B is also cooled with air as cooling fluid 3C. The remainder of the structure corresponds to the one described above. In contrast, however, an active conveying device 115B is provided, which directs the air as cooling fluid 3C at a greater pressure through the flow paths 110B of the main cooling system 11B than the air as is directed as cooling fluid 3B through the auxiliary cooling system 12A. Using air for both cooling systems enables a particularly great simplification of the drive unit 1.

According to FIG. 5, direct air cooling by the main cooling system 11B, and indirect air cooling by the auxiliary cooling system 12A, is thus provided.

FIG. 6 shows an alternative, wherein the main cooling system 12A is designed according to FIG. 3 and the auxiliary cooling system 12B also uses with a liquid, e.g. water or an oil, as cooling fluid 3D. In order to be able to circulate this cooling fluid 3D through the flow paths 120B, the drive unit 1 comprises a conveying device 115C (e.g. as described above).

According to FIG. 6, direct oil cooling by the main cooling system 11A, and indirect liquid cooling by the auxiliary cooling system 12B, is thus provided.

The main cooling system 12A and the auxiliary cooling system 12B are hydraulically separated from one another. The flow paths 110A of the main cooling system 12A have no direct boundary, e.g. in the form of a simple wall, in relation to the flow paths 120B of the auxiliary cooling system 12B.

The flow paths 120B of the auxiliary cooling system 12B are designed in the form of tubes with a circular cross section in a heat sink that surrounds the stator 100. The flow paths 110A of the main cooling system 12A are elongate in cross section. They extend along the coils 101.

Furthermore, the drive unit 1 of the example shown comprises a control unit 17. The control unit 17 is designed to detect whether the main cooling system 11A has a fault and to disable the latter based on this detected fault and to activate the auxiliary cooling system

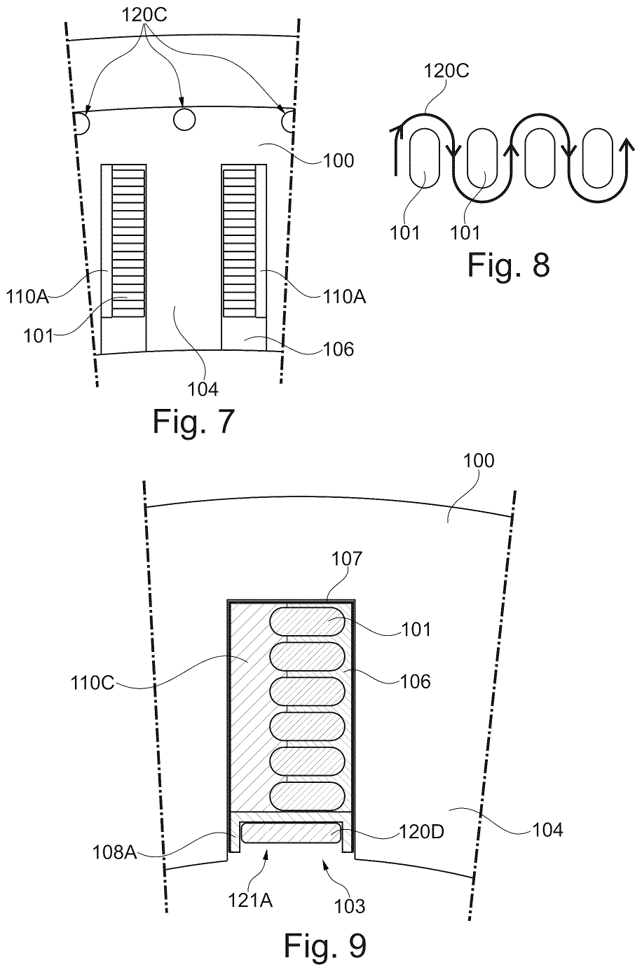

FIG. 7 shows a design embodiment similar to that of FIG. 6. In contrast, portions of a flow path 120C of the auxiliary cooling system 12B are formed here in the material of the stator 100 and not in a heat sink surrounding said stator, while that would also be possible alternatively. Further, a portion of the flow path 120C of the auxiliary cooling system 12B extends in each case between two portions of a coil 101, i.e. centrally on a tooth 104, when viewed in the circumferential direction.

It is furthermore provided that at least some of the portions of the flow paths 120C are connected to one another successively, when viewed downstream. Here, the flow path 120C extends in a meandering manner about the portions of the coils 101, as visualized by FIG. 8. Alternatively, e.g. straight flow paths that only run straight through the stator would be possible. The flow path 120C can be formed by a continuous tube. Alternatively, or additionally, the flow path or the flow paths 110A of the main cooling system 11A can be designed as a slot.

FIG. 9 shows a design embodiment in which both the flow paths 110C of the main cooling system 11A and the flow paths 120D of the auxiliary cooling system 12B are in each case disposed in grooves 103 between two teeth of the stator 100, conjointly with portions of the coils 101.

The flow paths 110C of the main cooling system 11A extend directly along the coils 101 (provided with an insulation), specifically on a plurality of windings of the latter. A cover 108A is disposed on an opening of the respective groove 103 that faces the rotor 102. The cover seals the respective flow path 110C of the main cooling system 11A. A line 121A that forms the respective flow path 120D of the auxiliary cooling system 12B is disposed on the cover 108A. The cover 108A receives the line 121A and encompasses the latter. Accordingly, the flow paths 120D of the auxiliary cooling system 12B extend between the coils 101 of the electric motor 10 and the rotor 102, which allows particularly effective cooling of the coil windings closest to the rotor 102. The cover 108A provides a separation between the flow paths 110C, 120D of main cooling system 11A and of the auxiliary cooling system 12B.

Presently, both cooling systems according to FIG. 9 are oil-cooled, wherein variants cooled with air or water are also conceivable, for example.

The coils 101 are adhesively bonded in the grooves 103 using a filling material, here in the form of a potting compound 106, specifically presently a resin, namely epoxy resin. An insulation 107 surrounds the respective coil 101, the flow path 110C of the main cooling system 11A and the flow path 120D of the auxiliary cooling system 12B.

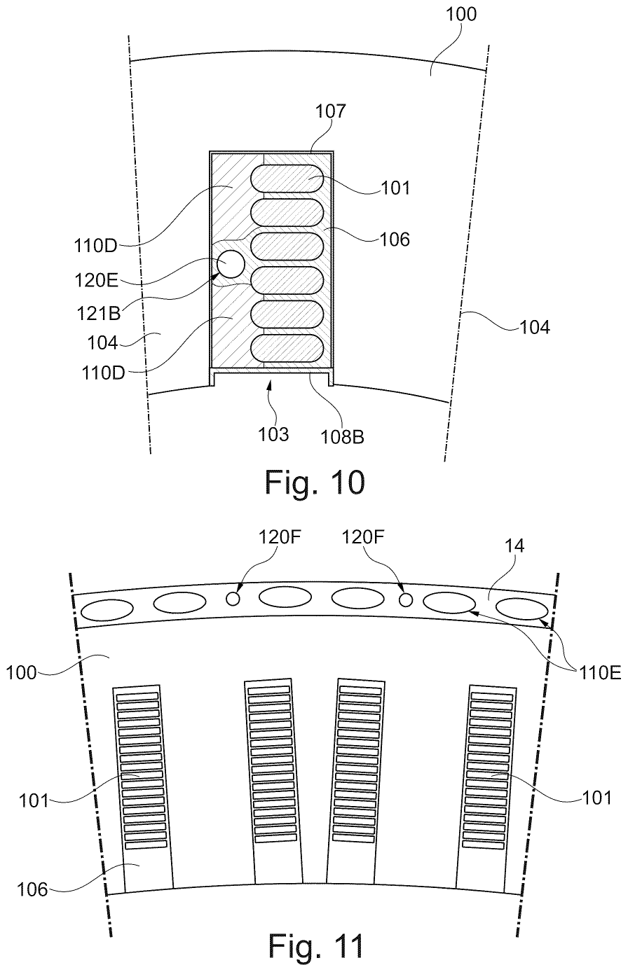

FIG. 10 shows a design embodiment according to which flow paths 110D of the main cooling system 11A, conjointly with a corresponding portion of the coils 101, are disposed in a respective groove 103 and sealed by a cover 108B.

Here, the flow paths 120E of the auxiliary cooling system 12B are formed by lines 121B, which are adhesively bonded to the coil 101 using the potting compound 106. Here, the potting compound 106 and the respective line 121B mutually separate two flow paths 110D of the main cooling system 11A. In terms of the height of the coil 101, the line 121B is positioned halfway up. The flow paths 110D of the main cooling system 11A have larger cross sections than the flow paths 120E of the auxiliary cooling system 12B. The flow paths 120E of the auxiliary cooling system 12B optionally run in a meandering manner.

The flow paths 120E of the auxiliary cooling system 12B extend in grooves 103 between teeth 104 of the stator 100.

FIG. 11 visualizes an alternative, according to which both the flow paths 110E of the main cooling system 11A and the flow paths 120F of the auxiliary cooling system 12B are disposed radially further outward than the coils 101 of the stator 100. Presently, the flow paths 110E of the main cooling system 11A and the flow paths 120F of the auxiliary cooling system 12B are provided in a heat sink 14 that externally surrounds the stator 101. Here, a larger number of flow paths 110E of the main cooling system 11A and of flow paths 120F of the auxiliary cooling system 12B are provided (which also have a larger length in total). In the example shown, two flow paths 110E of the main cooling system 11A alternate in each case with one flow path 120F of the auxiliary cooling system 12B.

Provided according to FIG. 11 is thus indirect liquid cooling by the main cooling system 11A and indirect liquid cooling by the auxiliary cooling system 12B.

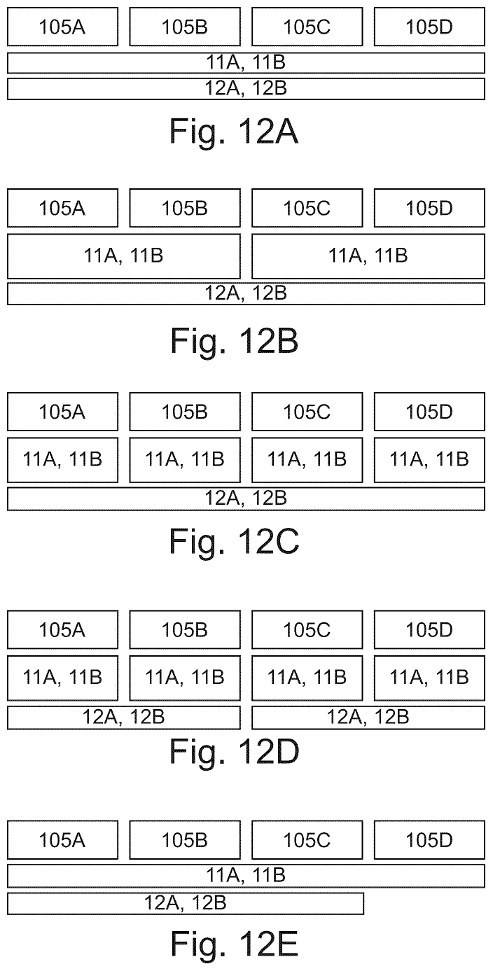

FIG. 12A visualizes a potential design embodiment of the drive system 1 with, by way of example, four strands 105A-105D. Both the main cooling system 11A, 11B and the auxiliary cooling system 12A, 12B are designed to cool each of the strands 105A-105D. At least part of the strands can be disposed to be mutually spaced apart. For example, the fourth strand 105D is disposed separately from the remaining strands 105A-105C, e.g. in other grooves 103, or axially offset from the remaining strands 105A-105C. For example, the fourth strand 105D is only intended for redundancy purposes and is only activated if one or a plurality of the remaining strands 105A-105C fail.

In this example, the main cooling system 11A, 11B is designed, for example, in such a way that it can discharge more than 50%, specifically in the present case 100%, of the heat output generated by the electric motor 10 (e.g. in terms of a 100% drive output of the electric motor 10). The auxiliary cooling system 12A, 12B is designed in such a way that it can discharge less than 100%, less than 50%, or 25%, of the heat output generated by the electric motor 10.

In the event of a failure of the main cooling system 11A, 11B, the electric motor 10 can further be operated with the auxiliary cooling system 12A, 12B at least at reduced power. In the event of a failure of the auxiliary cooling system 12A, 12B, the electric motor 10 can be operated unchanged.

If both cooling systems are activated, a particularly high cooling capacity, e.g. of 125%, can be achieved. A further advantage is an overall possible lower temperature level, which can have a beneficial effect on maintenance intervals.

FIG. 12B shows a variant according to which two separate main cooling systems 11A, 11B are provided, which cool in each case (only) two of the four strands 105A-105D. The auxiliary cooling system 12A, 12B, on the other hand, cools another number of strands 105A-105D, specifically all strands 105A-105D of the electric motor 10.

The main cooling systems 11A, 11B are designed in this example so that each can discharge 50% of the total heat output generated by the electric motor 10. The auxiliary cooling system 12A, 12B is designed in such a way that it can discharge 25% of the heat output generated by the electric motor 10 (e.g. in each case in terms of a 100% drive output of the electric motor 10).

Similarly, FIG. 12C visualizes a design embodiment in which the drive unit 1 for each strand 105A-105D has a main cooling system 11A, 11B provided individually only for this strand 105A-105D. The drive system 1 thus comprises four (optionally mutually independent) main cooling systems 11A, 11B. The auxiliary cooling system 12A, 12B, on the other hand, cools another number of strands 105A-105D, specifically all four strands 105A-105D of the electric motor 10.

The main cooling systems 11A, 11B are designed in this example so that each can discharge 25% of the total loss-to-heat output generated by the electric motor 10. In this example, each strand 105A-105D generates 25% of the total loss-to-heat output of the electric motor 10. The auxiliary cooling system 12A, 12B is designed so that it can discharge 10% of the loss-to-heat output generated by the electric motor 10.

Furthermore, FIG. 12D visualizes a design embodiment in which the drive unit 1 for each strand 105A-105D has a main cooling system 11A, 11B provided individually only for this strand 105A-105D. The drive system 1 thus comprises four main cooling systems 11A, 11B. The drive unit 1 further comprises a plurality of auxiliary cooling systems 12A, 12B. The respective auxiliary cooling system 12A, 12B, on the other hand, cools a different number of strands 105A-105D, specifically in each case two strands 105A-105D of the electric motor 10.

The main cooling systems 11A, 11B are designed in this example so that each can discharge 25% of the total loss-to-heat output generated by the electric motor 10. The auxiliary cooling system 12A, 12B is designed so that it can discharge 10% of the loss-to-heat output generated by the electric motor 10.

FIG. 12E shows a design embodiment corresponding to FIG. 12A, wherein the auxiliary cooling system 12A, 12B cannot cool a strand 105D, but is specified only to cool the remaining three strands 105A-105C.

The disclosure is not limited to the embodiments described above and different modifications and improvements can be made without deviating from the concepts described here. Any of the features may be used separately or in combination with any other features, unless they are mutually exclusive, and the disclosure extends to and includes all combinations and subsidiary combinations of one or more features that are described herein.

For example, it can be provided that the main cooling system 11A; 11B and/or the auxiliary cooling system 12A; 12B are/is specified to cool the electric motors 10 of a plurality of electric motors 10 of the aircraft 2. The electric motor 10 can be any type (permanently excited or inductive; as a radial flux machine, transverse flux machine or axial flux machine; as an internal rotor motor or external rotor; with distributed or concentrated winding; with rectangular conductors, stranded conductors, single-layer winding or two-layer winding for the coils), the coils 101 can be formed from rectangular conductors, stranded wires and the like. Further, cooling can alternatively or additionally be performed on axial ends of the coils 101. It is furthermore possible that the main cooling system or the auxiliary cooling system is based on evaporative cooling.

1. A drive unit for a vehicle, the drive unit comprising:
an electric motor;
a main cooling system for cooling the electric motor; and
an auxiliary cooling system independent of the main cooling system for cooling the electric motor,
wherein a cooling capacity of the main cooling system is greater that a cooling capacity of the auxiliary cooling system

2. (canceled)

3. The drive unit of claim 1, wherein the main cooling system has a flow path or a plurality of flow paths for a cooling fluid, and
wherein the auxiliary cooling system has a flow path or a plurality of flow paths for a cooling fluid.

4. The drive unit of claim 3, wherein the flow path or the plurality of flow paths of the main cooling system is separate from the flow path or the plurality of flow paths of the auxiliary cooling system.

5. The drive unit of claim 3, wherein the cooling fluid of the main cooling system is a liquid or air, and
wherein the cooling fluid of the auxiliary cooling system is a liquid or air.

6.-8. (canceled)

9. The drive unit of claim 3, wherein the electric motor is connected to the flow path or the plurality of flow paths of the main cooling system and/or to the flow path or the plurality of flow paths of the auxiliary cooling system by way of a heat sink.

10. The drive unit of claim 3, wherein the flow path or the plurality of flow paths of the auxiliary cooling system externally surrounds the flow path or the plurality of flow paths of the main cooling system.

11. The drive unit of claim 3, wherein the flow path or the plurality of flow paths of the main cooling system and/or the flow path or the plurality of flow paths of the auxiliary cooling system are designed in a meandering manner.

12. The drive unit of claim 3, wherein the flow path or the plurality of flow paths of the main cooling system is formed differently from the flow path or the plurality of flow paths of the auxiliary cooling system.

13. The drive unit of claim 3, wherein a respective cooling fluid of the main cooling system or the auxiliary cooling system is configured to be circulated by a conveying device through the respective flow path or the plurality of flow paths or is configured to flow in a form of external air from an inlet to an outlet.

14. The drive unit of claim 1, wherein the main cooling system and the auxiliary cooling system are each designed for continuous operation.

15. The drive unit of claim 1, wherein the main cooling system and the auxiliary cooling system are designed to release heat to external air independently of one another.

16. The drive unit of claim 1, wherein the main cooling system comprises a heat exchanger for discharging heat, and/or is configured to be passed through by a flow of external air, and
wherein the auxiliary cooling system comprises, separately from the main cooling system, a heat exchanger for discharging heat, and/or is configured to be passed through by a flow of external air.

17. The drive unit of claim 1, wherein the electric motor comprises a stator with electric coils and a rotor that is rotatable relative to the stator.

18. The drive unit of claim 17,
wherein the main cooling system has a flow path or a plurality of flow paths for a cooling fluid, and
wherein the electric coils of the electric motor are in contact with the cooling fluid flowing through the flow path or the plurality of flow paths of the main cooling system.

19. The drive unit of claim 17,
wherein the auxiliary cooling system has a flow path or a plurality of flow paths for a cooling fluid, and
wherein the flow path or the plurality of flow paths of the auxiliary cooling system extend between the electric coils of the electric motor and the rotor.

20. The drive unit of claim 17,
wherein the main cooling system has a flow path or a plurality of flow paths for a cooling fluid,
wherein the auxiliary cooling system has a flow path or a plurality of flow paths for a cooling fluid, and
wherein the flow path or the plurality of flow paths of the main cooling system and/or the flow path or the plurality of flow paths of the auxiliary cooling system extend in grooves between teeth of the stator.

21. The drive unit of claim 1, wherein the main cooling system is configured to provide more than 50% of a cooling requirement of the electric motor at maximum drive output, and the auxiliary cooling system is configured to provide less than 50% of the cooling requirement of the electric motor at the maximum drive output, and/or
wherein the main cooling system is configured to provide 100% of the cooling requirement of the electric motor at 50% or more of the maximum drive output, and/or
wherein the auxiliary cooling system is configured to provide 100% of the cooling requirement of the electric motor at 50% or less of the maximum drive output.

22. The drive unit of claim 1, wherein the electric motor comprises a plurality of mutually independent electrical strands and
wherein the main cooling system is configured to cool a different number of strands of the plurality of mutually independent electrical strands than the auxiliary cooling system.

23. An aircraft comprising:
a drive unit having:
an electric motor;
a main cooling system for cooling the electric motor; and
an auxiliary cooling system, independent of the main cooling system, for cooling the electric motor,
wherein a cooling capacity of the main cooling system is greater that a cooling capacity of the auxiliary cooling system.

24. The aircraft of claim 23, further comprising:
a further drive unit having a further electric motor,
wherein the main cooling system and/or the auxiliary cooling system are/is configured to cool the electric motor of the drive unit and the further electric motor of the further drive unit.
